(19) United States
(12) Patent Application Publication
(10) Pub. No.: US 2009/0226123 A1
(43) Pub. Date: Sep. 10, 2009

(54) Bearing Bush Assembly, Bearing and Semicircular Bearing Shell Half

(76) Inventor: Martin Klein, Walluf (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/922,962

(22) PCT Filed: Jun. 23, 2006
(86) PCT No.: PCT/EP2006/006061

§ 371 Date: May 6, 2009

(30) Foreign Application Priority Data
Jun. 23, 2005 (DE) 10 2005 030 307.2

(51) Int. Cl. F16C 33/02; F16C 33/10; F16C 9/02

(52) U.S. Cl. 384/276; 384/286; 384/294

(57) ABSTRACT

A bearing shell assembly has a bearing of length B₁ and having two bearing shell halves each having a width B₂<B₁/2 spaced from each other axially. An oil duct extending angularly of the bearing shell halves is formed between the bearing shell halves.

The invention relates to a bearing shell assembly, a bearing, and a semicylindrical bearing shell half. The invention also relates to a main crankshaft bearing and a mass balance transmission bearing.

U.S. Pat. No. 2,678,767 describes a bearing of the small connecting rod eye comprising two bushings set at a spacing from each other between which an oil duct is formed. Bearing shells are used less as bearings in large connecting rod eyes.

The crankshaft of a car or truck engine is mounted in so-called main bearings through which the connecting rod bearings are supplied with oil. The main bearings are formed with and without a collar. In order to guarantee this oil supply, the main bearing has an upper bearing shell having at least one oil bore and an oil groove extending essentially around the entire inner surface. The corresponding crankshaft pin has a radial oil bore through which the oil in the upper bearing shell is passed and provided to the connecting rod bearing. The upper bearing shell is made with and without a collar. Collar bearing shells of this type are known from U.S. Pat. No. 4,845,817, for example. As a rule, however, these bearing shells are so-called composite collar bearing shells in which the end disk engage on the bearing shell in a movable fashion.

Bearing shells with and without collars and with an oil groove are also used in so-called mass balance transmission bearings.

The requirements for bearing shells of this type relate to the size of the flow cross section of the oil groove, among other things. In order to be able to provide the largest amount of oil possible, a wide and deep oil groove is desirable. However, its depth is limited by the need for strength of the bearing shell. Due to the thinness of the material at the base of the groove, the back of the bearing shell may not rest completely in the bearing support. If the oil grooves are too wide, the remaining support area of the bearing shell is again too small.

Another disadvantage of conventional bearing shells lies in the fact that the oil groove must be produced by machining, that at least one oil bore must be formed, and that the material that is removed must be disposed of as waste. In producing the oil groove as well as in producing the oil bore, small filings (flakes) result. These filings are extremely disruptive to the production process and must be removed using expensive washing processes.

Therefore, the object of the invention is to provide a bearing shell assembly as well as a bearing, in particular a primary bearing for a crankshaft, and a mass balance transmission bearing that may be produced in a simple manner, with the flow cross section of the oil groove being greater than that of conventional bearing shells and the size of the support region remaining the same. The object of the invention is also to provide bearing shell halves for a bearing shell assembly of this kind.

This object is attained with a bearing shell assembly with a bearing length B₁ and having two semicylindrical bearing shell halves each with a width B₂<B₁/2 set at an axial spacing from each other, with an oil duct extending angularly of the bearing shell halves being formed between the bearing shell halves.

The invention preferably refers to bearing shells with an outside diameter of 20 mm to 150 mm.

The length B₁ of the bearing shell assembly includes the widths of both bearing shell halves and the width of the oil duct formed between the two bearing shell halves. This length B₁ is determined by the width B₃ of the bearing shell support or bearing bore in the bearing housing. In the case of bearing shell halves with axial bearing parts located on the edge, the bearing shell halves are located opposite the bearing bore, such that B₃<B₁. In general, B₃≦B₁.

An oil duct is formed between the two bearing shell halves; according to the invention, the entire thickness of the bearing shell is available for its radial depth. If the widths B₂ of the two bearing shell halves correspond to the width of the support surface portion of conventional individual bearing shells with an oil groove, the oil duct has a greater flow cross section than the oil groove in the conventional bearing shell. Conversely, if the oil duct has the same flow cross section as conventional bearing shells, the amount of supporting surface may be increased by a correspondingly greater width of the bearing shell halves.

The width of the oil duct and thus the flow cross section may be selected by the user by establishing the axial spacing between the bearing shell halves by selecting the width B₂.

The expensive formation of the oil groove is eliminated, no filings are produced, and at the same time a considerable amount of bearing shell material is saved.

Preferably, each bearing shell has an axial bearing part on its end edge. While in conventional collar bearing shells the mass between the two axial bearing parts is fixed, it is now possible for this mass to be freely selected. The bearing shell halves may thus be used in a variable fashion.

Preferably, the two bearing shell halves are identical. This simplifies their manufacture considerably.

Preferably, the oil duct extends over the entire angular length of the baring shell halves. The two bearing shell halves are not in contact with one another.

A particular use of at least two semicylindrical bearing shell halves is provided for oil-lubricated bearings, in particular in vehicle motors.

The oil-lubricated bearing with one first and one second bearing shell that are adjacent to one another on their partial surfaces is characterized in that at least one of the two bearing shells has been divided in two and is composed of two semicylindrical bearing shell halves that are mounted at a spacing from each other axially of the bearing, with an oil duct extending angularly being formed between the bearing shell halves.

The main crankshaft bearing according to the invention having a bearing bore with the width B₃ and a bearing assembly with a length B₁ and including an upper shell and a lower shell placed in the bearing housing, with the bearing housing having at least one oil supply to the upper shell, is characterized in that the upper shell is divided in two and is formed by two semicylindrical bearing shell halves that are spaced from each other axially of the bearing, with an oil duct extending angularly into which the oil supply empties being formed between the bearing shell halves.

The bearing shell halves of the main crankshaft bearing and the mass balance transmission bearing may optionally be provided with axial bearing parts, or not.

A semicylindrical bearing shell half with a width B₂ having an outside diameter D as well as partial surfaces is characterized in that the bearing shell half may be used in conjunction with a second semicylindrical bearing shell half with a width B₂ to form a bearing shell assembly with a bearing length B₁, with the two bearing shell halves being spaced from each other, with an oil groove that extends angularly of the bearing shell halves being between the bearing shell halves, and in that the following applies to the ratio V between the outside diameter D of the bearing shell in mm and the width B₂ of the bearing shell half in mm:

2.5≦V≦6 for 20≦D≦24

2.4≦V≦10 for 24≦D≦40

4≦V≦8.5 for 40<D≦60

5≦V≦20 for 60≦D≦100

4.8≦V≦20 for 100<D≦150

Preferably, the semicylindrical bearing shell half has at least one retaining formation in the partial surface that projects opposite the outer surface of the bearing shell half. According to a special embodiment, one retaining formation each is provided in each partial surface. The provision of at least one retaining formation each in each partial surface has the advantage that a high degree of precision in alignment is guaranteed and axial slippage in the bearing support is prevented.

Preferably, the semicylindrical bearing shell half is characterized by an axial bearing part that is arranged on one edge of the bearing shell half.

The bearing shell halves are distinguished by a low level of tilt by the partial surfaces (≦0.03 mm) relative to the apex.

Illustrated embodiments of the invention are described in greater detail below with reference to the drawings.

Therein:

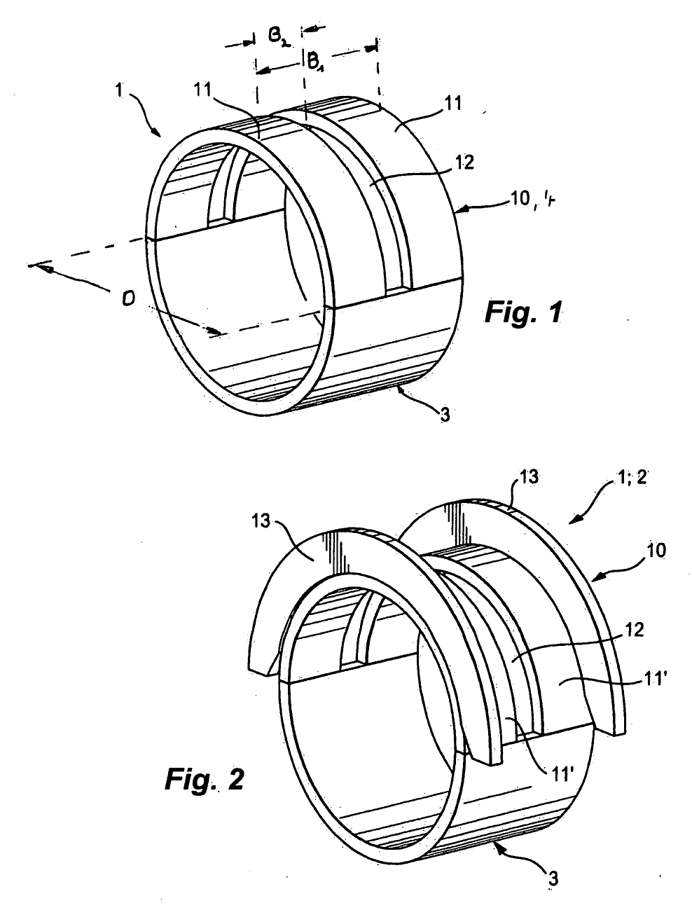

FIG. 1 is a perspective view of a bearing according to a first embodiment,

FIG. 2 is a perspective view of a bearing according to another embodiment,

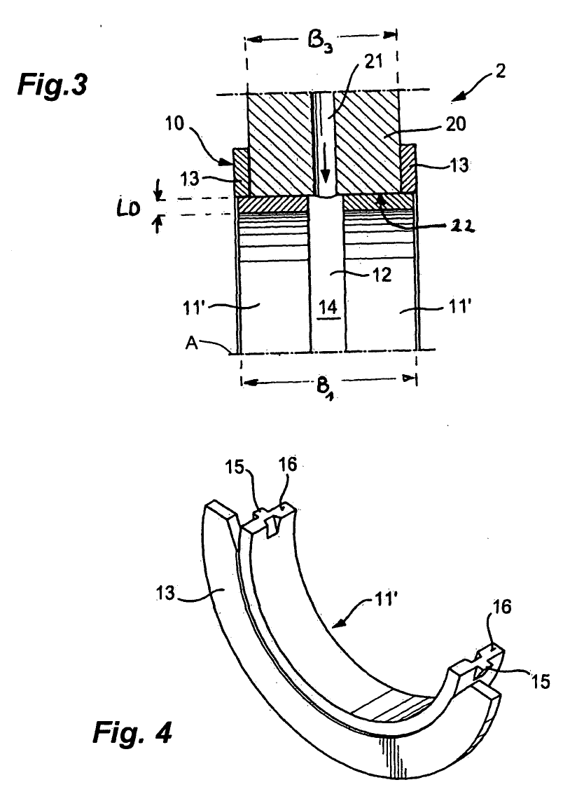

FIG. 3 is a section through the bearing assembly from FIG. 2 in its installed state, and

FIG. 4 shows a bearing shell half according to another embodiment.

FIG. 1 shows a bearing 1 with an upper shell 4 and a lower shell 3. While the lower shell 3 is a one-piece smooth shell, the upper shell 4 has two parts and is composed of a bearing shell assembly 10 with a length B₁ having two semicylindrical bearing shell halves 11 with a width B₂ that are arranged at a spacing from each other such that an intermediate space 12 is formed between the two bearing shell halves 11 that forms an oil duct 14 together with the bearing housing in its installed state. This is explained in greater detail in conjunction with FIG. 3.

FIG. 2 shows another embodiment of a bearing 1, with the upper shell 4 also being made in two pieces. The bearing shell assembly 10 is formed by two bearing shell halves 11′ arranged at a spacing from each other, each of which has an axial bearing part 13 on its outer edge. Bearings of this type are used as main crankshaft bearings 2, among other things. The lower shell 3 is composed of a one-piece smooth shell in this example as well.

A lower shell that has two pieces and is formed by two bearing shells arranged at a spacing from each other may also be used in combination with a single upper shell in mass balance transmission bearings.

FIG. 3 shows a partial section of the bearing 1 shown in FIG. 2, with the section running through the bearing shell assembly 10. In addition, A bearing housing 20 is shown having at its center an oil-supply passage 21. This oil supply 21 empties into the intermediate space 12 between the two bearing shell halves 11′ forming the oil duct 14. The entire bearing shell thickness LD is available for the oil duct 14.

FIG. 3 shows a main crankshaft bearing 2 whose bearing housing 20 is formed by a connecting rod. In this example, the bearing support 22 is the large connecting rod eye.

FIG. 3 is shows a mass balance transmission bearing, with the lower shell in this case being formed by two bearing shell halves arranged next to one another axially.

FIG. 4 shows a perspective view of a bearing shell half with an axial bearing part 13. Each end 16 of the semicylindrical bearing shell half 11′ has a retaining formation 15 that projects radially outward.

The following table shows the length B₂ and the ratio V=D/B₂ for the bearing shell halves, with D designating the outer diameter of the bearing shells. In addition, the associated widths B₁ of the bearing shell assembly are listed. B₁ therefore also includes the width B₄ of the oil duct.

TABLE

| D [mm] | B₁ [mm] | B₂ [mm] | V = D/B₂ [mm] | B₄ [mm] |
|---|---|---|---|---|
| 20 to 22 | 10-20 | 4-8 | 5.5-2.5 | 2-12 |
| >22 to 24 | 10-20 | 4-8 | 6-2.75 | 2-12 |
| >24 to 28 | 20-22 | 4-10 | 7-2.4 | 2-14 |
| >28 to 34 | 12-22 | 4-10 | 8.5-2.8 | 2-14 |
| >34 to 40 | 12-25 | 5-10 | 8-2.4 | 2-17 |
| >40 to 45 | 12-25 | 5-10 | 9-4 | 2-15 |
| >45 to 60 | 12-25 | 5-10 | 12-4.5 | 2-15 |
| >60 to 80 | 12-28 | 5-12 | 16-5 | 2-18 |
| >80 to 100 | 12-35 | 5-12 | 20-6.7 | 2-25 |
| >100 to 120 | 14-40 | 6-15 | 20-6.7 | 2-28 |
| >120 to 150 | 25-60 | 10-25 | 15-4.8 | 5-40 |

### REFERENCE CHARACTERS

1 Bearing
2 Main crankshaft bearing
3 First bearing shell
4 Second bearing shell
10 Bearing shell assembly
11, 11′ Semicylindrical bearing shell half
12 Intermediate space
13 Axial bearing part
14 Oil duct
15 Retaining formation
16 Partial surface
20 Bearing housing
21 Oil supply
22 Bearing support

1. A bearing shell assembly having a bearing of length B₁ and having two bearing shell halves each having a width B₂<B₁/2 arranged at a spacing from each other axially, an oil duct extending angularly of the bearing shell halves being formed between the bearing shell halves.

2. The bearing shell assembly according to claim 1 wherein each bearing shell half has an axial bearing part on one edge.

3. The bearing shell assembly according to claim 1 wherein both bearing shell halves are identical.

4. The bearing shell assembly according to claim 1 to 3 wherein the oil duct extends over the entire angular length of the bearing shell halves.

5. An oil-lubricated bearing with one first and one second bearing shell that are adjacent to one another on their partial surfaces wherein at least one of the bearing shells has two parts and is formed by two semicylindrical bearing shell halves spaced from each other axially of the bearing, an oil duct extending angularly being formed between the two bearing shell halves.

6. A main crankshaft bearing having a bearing housing with a width B₃ and a bearing assembly with a length B₁ used in the bearing housing including an upper shell and a lower shell, the bearing housing having at least one oil supply on the upper shell wherein the upper shell has two parts and is formed by two semicylindrical bearing shell halves spaced from each other axially of the bearing, an angularly extending oil duct into which the oil supply empties being formed between the bearing shell halves.

7. A mass balance transmission bearing with a bearing housing having a bearing bore with a width B₃ and an upper shell set in the bearing housing and a lower shell, with the bearing housing having at least one oil supply to the lower shell wherein the lower shell has two parts and is formed by two semicylindrical bearing shell halves spaced from each other axially of the bearing, an angularly extending oil duct formed between the bearing shell halves into which the oil supply empties.

8. A semicylindrical bearing shell half with a width B₂ having an inner diameter D as well as partial surface wherein the bearing shell half may be combined with a second semicylindrical bearing shell half with a width B₂ to form a bearing shell assembly with a length B₁ for a bearing, the two bearing shell halves being located between the bearing shell halves, and
in that the following applies for the ratio V of the outer diameter D of the bearing shell in mm to the width B₂ in mm of the bearing shell half:
2.5≦V≦6 for 20≦D≦24
2.4≦V≦8.5 for 24<D≦40
4≦V≦12 for 40<D≦60
5≦V≦20 for 60<D≦100
4.8≦V≦20 for 100<D≦150.

9. The semicylindrical bearing shell half according to claim 8, characterized by at least one retaining formation in the partial surface that projects opposite the surface of the outer circumference.

10. The semicylindrical bearing shell half according to claim 8, further having one retaining formation in each of the partial surfaces.

11. The semicylindrical bearing shell half according to claim 8, further having to an axial bearing part that is arranged on one edge of the bearing shell half.
